(19) United States
(12) Patent Application Publication
(10) Pub. No.: US 2020/0118207 A1
(43) Pub. Date: Apr. 16, 2020

(54) BLOCKCHAIN BASED INVOICE SALES

(71) Applicant: Hive Project Limited, Tortola (VG)

(72) Inventor: Dejan Jovanovic, Toronto (CA)

(21) Appl. No.: 16/424,701

(22) Filed: May 29, 2019

Related U.S. Application Data
(60) Provisional application No. 62/744,316, filed on Oct. 11, 2018.

(51) Int. Cl. G06Q 40/04; G06Q 20/38

(52) U.S. Cl. CPC G06Q 40/04; G06Q 20/389

(57) ABSTRACT

An apparatus and method facilitate sale of an invoice from a seller to a buyer. An invoice is received, by the apparatus, for sale by a seller, the invoice to be paid by a payer after the sale of the invoice to a buyer. The apparatus accesses a blockchain associated with both the seller and the buyer of the invoice, the blockchain storing a ledger of past invoice sales by the seller and past invoice purchases by the buyer. The apparatus generates a first rating score for the seller and a second rating score for the payer, the first and second rating scores being based on the ledger of past invoice sales by the seller stored on the blockchain and past invoice payments by the payer, respectively. The apparatus sends an offer to a buyer to sell the invoice at a discounted price.

### CROSS-REFERENCE TO RELATED APPLICATION

This application claims priority from U.S. Pat. App. Ser. No. 62/744,316 filed Oct. 11, 2018, entitled “BLOCKCHAIN BASED INVOICE SALES”, the entire disclosure of which is hereby incorporated by reference in its entirety.

### BACKGROUND OF THE DISCLOSURE

### 1. Field of the Disclosure

The disclosure relates in general to invoice sales, and more particularly, to blockchain based invoice sales.

### 2. Background Art

The current model in many industries such as finance is rather disorganized, wherein multiple entities maintain their own databases and data sharing can become very difficult due to the disparate nature of each of their systems. This is true for typical invoice buying and selling. Moreover, small and medium-sized enterprises (SMEs) have difficulty managing their liquidity risks if their invoice receivables have long payment periods. In addition, such SMEs have difficulty obtaining financing, especially in times of economic recessions when difficulty increases getting financing from financial institutions, particularly when having invoice receivables.

### SUMMARY OF THE DISCLOSURE

The disclosure is directed to a method of facilitating the sale of invoices. The method includes receiving, by the apparatus, an invoice for sale by a seller, the invoice to be paid by a payer after the sale of the invoice to a buyer, and accessing, by the apparatus, a blockchain associated with both the seller and the buyer of the invoice, the blockchain storing a ledger of past invoice sales by the seller and past invoice purchases by the buyer. The method further includes generating, by the apparatus, a first rating score for the seller and a second rating score for the payer, the first and second rating scores being based on the ledger of past invoice sales by the seller stored on the blockchain and past invoice payments by the payer, respectively. The method further includes sending, by the apparatus, an offer to a buyer to sell the invoice at a discounted price, the offer to sell including the first and second rating scores of the seller and the payer, and receiving, by the apparatus, an offer from the buyer to buy the invoice at the discounted price. The method further includes updating, by the apparatus, the ledger of past invoice sales by the seller on the blockchain in response to the apparatus receiving the discounted price from the buyer for the sale of the invoice and a record of past invoice payments by the payer in response to the apparatus receiving notice that the payer paid the debt associated with the invoice.

In some configurations, the blockchain of the method is a private blockchain, the method further comprising periodically synchronizing the private blockchain with a public blockchain.

In some configurations, the method further includes receiving at least one of government issued currency, cryptocurrency, and propriety tokens, from the buyer for the invoice.

In some configurations, the blockchain of the method is one of a private blockchain and a public blockchain.

In some configurations, the method further includes calculating at least one of the first rating score and the second rating score based on uploaded financial statements uploaded by at least one of the seller and the payer, respectively.

In some configurations, the method further includes calculating at least one of the first rating score and the second rating score based the Altman Z-score calculation formula.

In some configurations, the method further includes calculating a combined rating score based the first rating score and the second rating score, wherein the first and second rating scores of the offer include the combined rating score as a basis for the buyer to buy the invoice at the discounted price.

In some configurations, the method further includes weighting the combined score towards one of the seller and the payer.

In some configurations, the method further includes calculating the discounted price based on linear regression, with a maximum discount applied to the discounted price at a beginning of a specified time and a minimum discount applied to the discounted price at an end of the specified time.

In some configurations, the method further includes calculating the first rating score based on at least one seller criteria including assets, current liabilities, working capital, retained earnings, earnings before interest and taxes, total liabilities, total assets, gross sales, social media rating, liquidity, payment discipline, corporate intelligence information, and court proceedings.

The disclosure is also directed to an apparatus comprising a transceiver and a processor. The transceiver receives an invoice for sale by a seller, the invoice to be paid by a payer after the sale of the invoice to a buyer, and accesses a blockchain associated with both the seller and the payer of the invoice, the blockchain storing a ledger of past invoice sales by the seller. The processor generates a first rating score for the seller and a second rating score for the payer, the first and second rating scores being based on the ledger of past invoice sales by the seller stored on the blockchain and past invoice payments by the payer, respectively. The transceiver further sends an offer to the buyer to sell the invoice at a discounted price, the offer to sell including the first and second rating scores of the seller and the payer and receive an offer from the buyer to buy the invoice at the discounted price. The processor further updates the ledger of past invoice sales by the seller on the blockchain in response to the apparatus receiving the discounted price from the buyer for the sale of the invoice and a record of past invoice payments by the payer in response to the apparatus receiving notice that the payer paid the debt associated with the invoice.

In some configurations, the blockchain accessed by the apparatus is a private blockchain, the processor to further periodically synchronize the private blockchain with a public blockchain.

In some configurations, the transceiver further receives at least one of government issued currency, cryptocurrency, and propriety tokens, from the buyer for the invoice.

In some configurations, the blockchain accessed by the apparatus is one of a private blockchain and a public blockchain.

In some configurations, the processor further calculates at least one of the first rating score and the second rating score based on uploaded financial statements uploaded by at least one of the seller and the payer, respectively.

In some configurations, the processor further calculates at least one of the first rating score and the second rating score based the Altman Z-score calculation formula.

In some configurations, the processor further calculates a combined rating score based the first rating score and the second rating score, wherein the first and second rating scores of the offer include the combined rating score as a basis for the buyer to buy the invoice at the discounted price.

In some configurations, the processor further weights the combined score towards one of the seller and the payer.

In some configurations, the processor further calculates the discounted price based on linear regression, with a maximum discount applied to the discounted price at a beginning of a specified time and a minimum discount applied to the discounted price at an end of the specified time.

In some configurations, the processor further calculates the first rating score based on at least one seller criteria including assets, current liabilities, working capital, retained earnings, earnings before interest and taxes, total liabilities, total assets, and gross sales, social media rating, liquidity, payment discipline, corporate intelligence information, and court proceedings.

### BRIEF DESCRIPTION OF THE DRAWINGS

The disclosure will now be described with reference to the drawings wherein:

FIG. 1 illustrates an example system for buying and selling invoice(s) including an invoice processing and risk analysis (SIPRA), in accordance with the embodiments disclosed herein.

FIG. 2 illustrates example function modules of the SIPRA, in accordance with the embodiments disclosed herein.

FIG. 3 illustrates example high level interaction between a seller, a payer, and a buyer each using the SIPRA, in accordance with the embodiments disclosed herein.

FIG. 4 illustrates an example of a high-level architecture of the SIPRA shown in FIG. 1, in accordance with the embodiments disclosed herein.

FIG. 5 illustrates example actions that are available to be performed on the invoice, in accordance with the embodiments disclosed herein.

FIG. 6 illustrates an example invoice lifecycle, in accordance with the embodiments disclosed herein.

FIG. 7 illustrates example sell options available to the seller of the invoice, in accordance with the embodiments disclosed herein.

FIG. 8 illustrates an example flow of funds to/from the SIPRA, in accordance with the embodiments disclosed herein.

FIG. 9 illustrates another example high level architecture including the SIPRA for buying and selling the invoices, in accordance with the embodiments disclosed herein.

FIG. 10 illustrates an exemplary general-purpose computing device, in accordance with the embodiments disclosed herein.

FIG. 11 illustrates an example flowchart for a method of buying and selling invoices, in accordance with the embodiments disclosed herein.

### DETAILED DESCRIPTION OF THE DISCLOSURE

While this disclosure is susceptible of embodiments in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

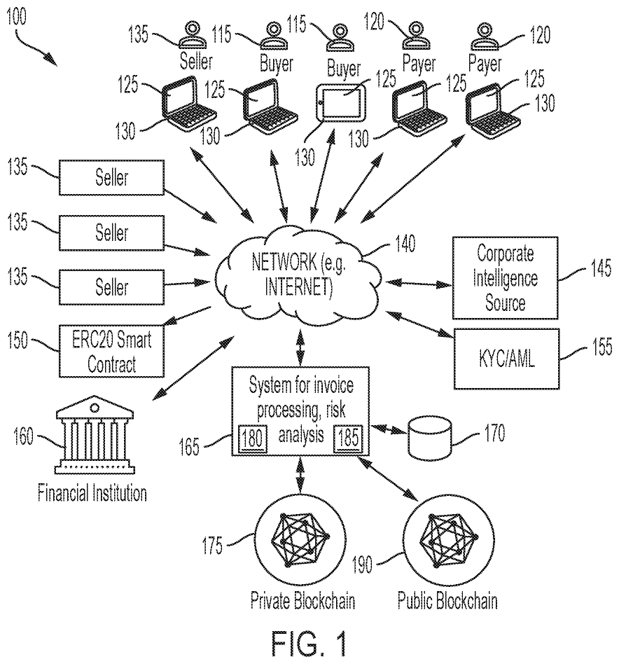

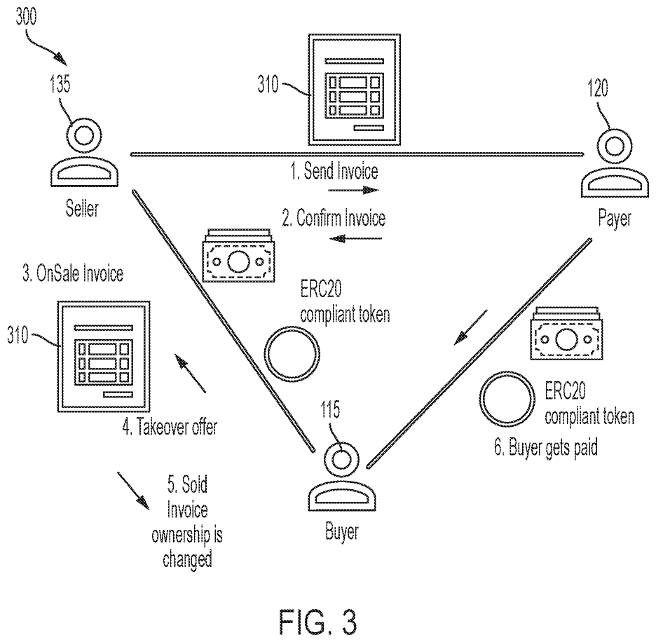

Referring now to the drawings and in particular to FIG. 1, FIG. 1 illustrates an example system 100 for buying and selling invoice(s) 310 (FIG. 3) including an apparatus, such as the SIPRA 165, in accordance with the embodiments disclosed herein. The system 100 includes a communication network 140, such as a peer-to-peer network, the Internet, or any other network that allows for communications within the system 100. Coupled to the communication network 140 are user equipment (UE) 130 having respective displays 125 used by buyers (investors) 115, payers 120, also referred to as debtors, such as an entity that is indebted on an invoice 310 (FIG. 3), and sellers (assignors) 135. For simplicity, this description describes various information being sent to and received by the UE 130 of the buyers 115, the payers 120, and the sellers 135, referenced herein simply as the buyer 115, the payer 120, and the seller 135, with an understanding that the buyers 115, the payers 120, and the sellers 135 use the UEs 130 to send and receive the data and funds described herein. Further coupled to the communication network 140 is a Know Your Customer/Anti-money Laundering (KYC/AML) services 155, a corporate intelligence source 145, a financial institution 160, an apparatus for blockchain based invoice sales contracting, or “smart contracting”, such as the SIPRA 165, a local database 170, a private blockchain 175, and a public blockchain 190. The SIPRA 165 includes a processor 180, such as a microprocessor, and a transceiver 185. The processor 180 performs the functions described herein by the SIPRA 165 and the transceiver 185 transmits and receives the various data and funds described herein. Although both a private blockchain 175 and a public blockchain 190 are illustrated as being accessed by the SIPRA 165, in at least one embodiment only the private blockchain 175 is accessed Likewise, in at least one embodiment, only the public blockchain 190 is accessed.

The private blockchain 175 and the public blockchain 190 serve as a single shared ledger among interested parties, which results in simplified invoice sales by reducing the complexity of managing separate systems typically maintained by each entity involved for such sales. The system 100 is based on the blockchain technology, such as the private blockchain 175 and the public blockchain 190. The system 100 is based on a “State Channel” design pattern with blockchain integration that allows for transparency and trust for settled invoices 310. In at least one embodiment, the private blockchain 175 and the public blockchain 190 combine off-chain and on-chain processing. This combination of processing provides performance and security for customers, such as the seller 135, the buyer 115, and the payer 120 of the system 100 while simultaneously providing for transparency and immutability for the data within the system 100. This approach is referenced as State Channel and solves performance problems associated with typical public blockchain.

Benefits of building the system 100 on the private blockchain 175 and the public blockchain 190 include decentralization, transparency and trust, immutability, high availability, high security, faster dealings, and cost saving. For decentralization, the system 100 does not need a trusted third party or intermediary to validate sale transactions of the invoice 310, but instead uses a consensus mechanism to agree on the validity of such transactions. As blockchains are shared and available for review on the private blockchain 175 and the public blockchain 190, such benefits provide for transparency and trust, allowing the system 100 based on the private blockchain 175 and the public blockchain 190 to be transparent and as a result trust is established. This transparency and trust are particularly relevant in scenarios such as the disbursement of funds or benefits where personal discretion should be restricted. For immutability, once data has been written into the private blockchain 175 and the public blockchain 190, it is extremely difficult to change. Although the private blockchain 175 and the public blockchain 190 are immutable, any changes to data stored therein is completely transparent, thus eliminating trust issues for the data stored therein, this is a benefit to maintaining or storing the ledger 310 described herein on the private blockchain 175 and the public blockchain 190.

In an example embodiment, the private blockchain 175 is a sub-chain of the public blockchain 190. This is done in order to achieve desired performance, reliability and security. The private blockchain 175 is used as a main distributed ledger and, periodically, a current chain state of the private blockchain 175 is submitted to the public blockchain 190. That is, the ledger described herein within public blockchain 190 is synchronized with the previously stored ledger of the private blockchain 175. A state of the private blockchain 175 is constructed as a Merkle root which presents the cryptographic signature of all transactions contained in this blockchain. This constructed cryptographic signature insures the authenticity and integrity of data stored on public blockchain 190.

For high availability, as the system 100 can be based on thousands of nodes in the communication network 140, such as the Internet, and the data is replicated and updated on each and every node, the system 100 becomes highly available. Even if nodes leave the communication network 140 or become inaccessible, the system 100 as a whole continues to operate, thus making it highly available. For high security, all transactions on the private blockchain 175 and the public blockchain 190 are cryptographically secured and therefore provide integrity to the sale of invoices 310. For faster dealings, in the financial industry, especially in post-trade settlement functions, the use of the private blockchain 175 and the public blockchain 190 for the sale of invoices 310 allows for quicker settlement of the sale as it does not require a lengthy process of verification, reconciliation, and clearance. This is because a single version of agreed upon data is made available on a shared ledger on the private blockchain 175 and the public blockchain 190. For cost saving, no third party or clearing houses are required by the system 100, which can massively eliminate overhead costs in the form of fees that are paid to clearing houses or trusted third parties.

As used herein, account receivables is money that a company has a right to receive because it had provided customers with goods and/or services. For example, a manufacturer has an account receivables when it delivers a truckload of goods to a customer on June 1 and the customer is to pay for the goods within 30 days. From June 1 until the company receives the money, the company has the account receivables (and the customer has an account payables). Account receivables are also known as trade receivables. As used herein, account payables is money owed by a business to its suppliers of goods and/or services shown as a liability on a company's balance sheet. Account receivables is distinct from notes payable liabilities, which are debts created by formal legal instrument documents. In an example, the seller 135 is a company providing at least one of goods and services, associated with the invoice 310. In another example, the seller 135 is a previous buyer of a particular invoice 310, such that the seller 135 does not want to wait for payment on the invoice 310 from the payer 120. In another example, the buyer 115 is at the same time the payer 120 of the invoice 310, the payer 120 offering to settle its debt before a due date at a discount. The SIPRA 165 sends a notification to the payer 120 that the seller 135 has uploaded a particular invoice with a request to payer 120 to either validate the invoice 310 or buy the invoice 310.

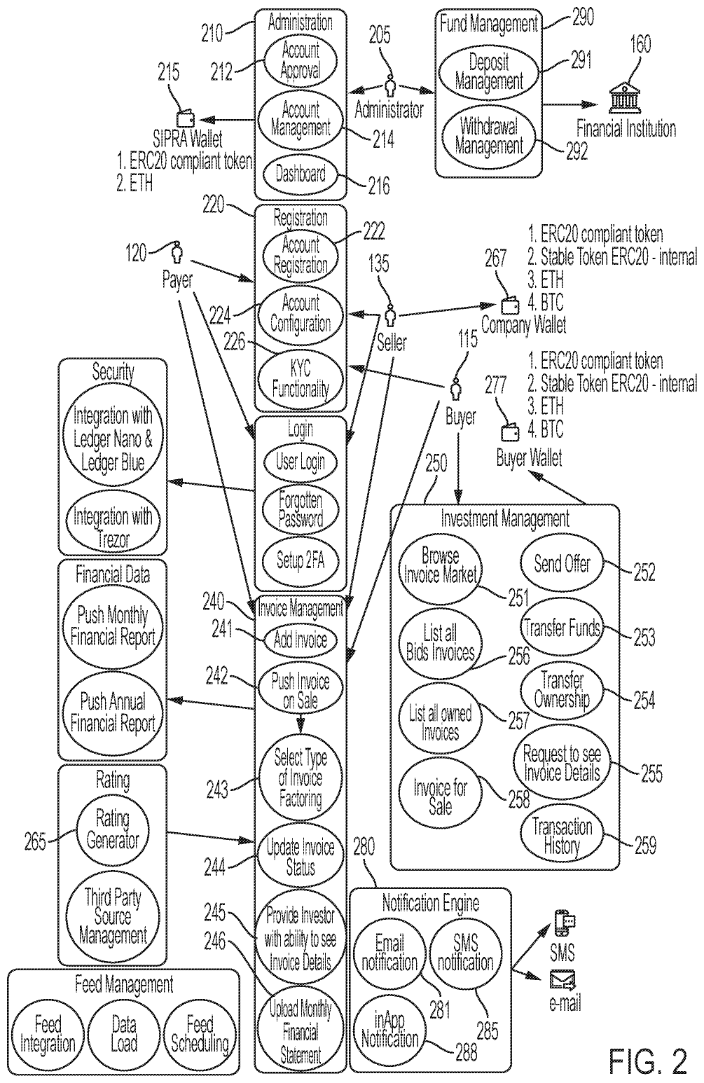

The SIPRA 165 facilitates the sale of invoices, as discussed in further detail below. If the seller 135, such as a company user, decides to sell the invoice 310 instead of waiting for payment from the payer 120, the seller 135 will transfer, via the SIPRA 165, ownership to the buyer 115. For those invoices that the seller 135 has offered for sale (referred to herein as “OnSale”) on the SIPRA 165 and agreed on to account terms, ownership will be changed to the buyer 115 at the moment when the SIPRA 165 receives funds, such as EURO, Dollar, etc., cryptocurrency, such as bitcoin tokens, Ethereum tokens, and/or proprietary tokens of the SIPRA 165, from a buyer's 115 digital wallet 277 (FIG. 2) in the amount that is equal to value of the sale in funds. In at least one embodiment, the seller 135 only receives the proprietary tokens of the SIPRA 165 from the buyer's 115 digital wallet 277 for transfer cost and confirmation from the seller 135 that the invoice has been sold. In at least one embodiment, cost related to transfer of ownership will be paid in the proprietary tokens of the SIPRA 165 from the buyer's 115 digital wallet 277 regardless of how funds have been sent to the seller 135. In at least one embodiment, the buyer 115 buys the proprietary tokens of the SIPRA 165 from outside the SIRPA 165 and uses these to pay for the transactions described herein on the SIPRA 165. In other embodiments, a crypto exchange Application Programming Interface (API) is integrated with the SIPRA 165 for a buyer 115 to buy the proprietary tokens of the SIPRA 165. In other embodiments, buyers 115 can use crypto currencies to pay for the invoices 310 and/or other services, such as SIPRA 165 services or third-party services.

The seller 135 updates a status of the invoice 310, marking it as paid. In at least one embodiment, only the seller 135 can update the status of the invoice 310. In at least one embodiment, security for such an update is insured by private key. The SIPRA 165 captures a date of closing for such a sale, updating the private blockchain 175, accordingly. In the case that the invoice 310 is closed and that at approximately a same time that same invoice 310 is in a process to be sold to buyer 115, the status of the invoice 310 is updated by the SIPRA 165 if it is still in the ownership of the seller 135 and takeover sale funds will be send back to the buyer 115.

The SIPRA 165 also provides rating scoring of the sellers 135 and the payers 120 that are members of the SIPRA 165, and even for the payers 120 if they are not members of the SIPRA 165. Such scoring is based on an invoice history, such as based on past invoices sales by the seller 135, that have been stored on the private blockchain 175 and/or the local database 170, and past invoice payments by the payer 120 (e.g., stored on the SIPRA 165, and/or the private blockchain 175 and/or the local database 170), financial data available for/from the seller 135 and the payer 120 stored on the private blockchain 175 and/or the local database 170, such as on a monthly basis, and/or financial information about the seller 135 and the payer 120 from third party providers (e.g. corporate intelligence sources 145). Initially, this financial information about the seller 135 and the payer 120 from third party providers is used as a basis to score rate the invoice 310. Thereafter, after the SIPRA 165 builds the information stored on the local database 170, the private blockchain 175 and the public blockchain 190, such information from the local database 170, the private blockchain 175 and the public blockchain 190 is also used as a basis to generate the rating score. In at least one embodiment, the seller 135 and the payer 120 can upload monthly financial statements to the SIPRA 165 for the calculated rating.

At least one of the seller 135 and the payer 120 are able to manually update a status of the invoice 310 on the SIPRA 165. Marking the invoice 310 as paid will trigger a status change and therefore result in listing the invoice 310 under a paid section on the display 125. In at least one embodiment, the SIPRA 165 will only list on the display 125 an amount of the invoice 310, creation date of the invoice 310, due date of the invoice 310, takeover amount of the invoice 310, an industry/main activity of the underlying sellers 135 and payers 120, and risk score associated with the invoice. In at least one embodiment, other information, such as payer 120 name, seller 135 name, and invoice number are by default hashed over so as to not be viewable.

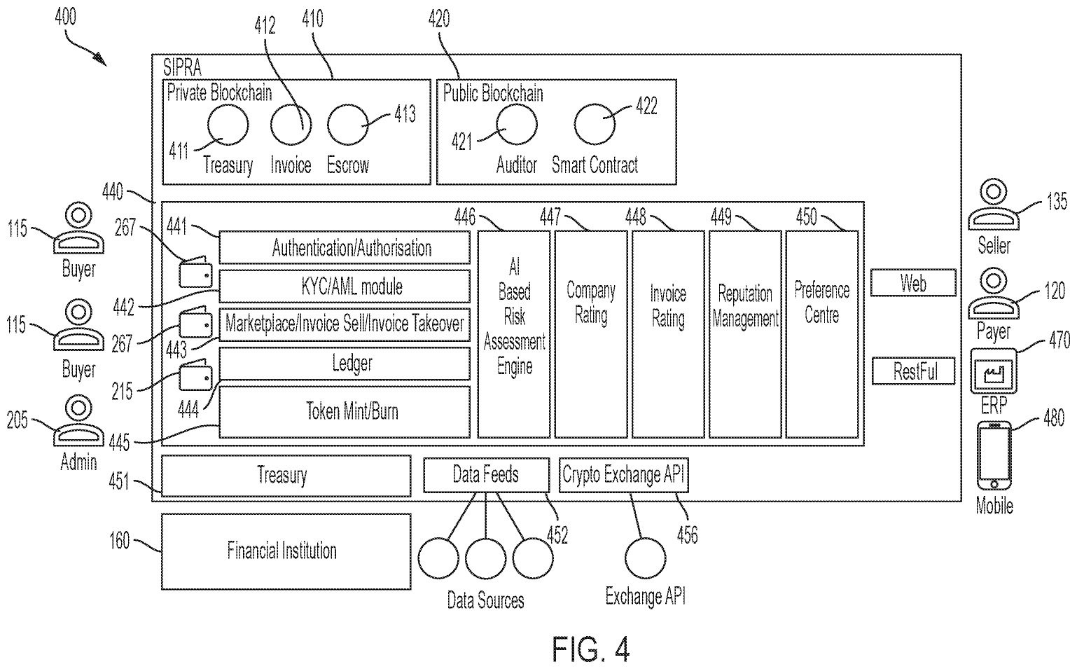

In order to provide the buyer 115 with risk factoring information, i.e., rating score, for the seller 135 and the payer 120, in at least one embodiment the Altman Z-score calculation formula is used as a basis to calculate such for the seller 135 and the payer 120. In at least some embodiments, these two individually calculated scores for the seller 135 and the payer 120 are thereafter used to calculate a combined score that is presented to the buyer 115 as a basis for making an informed decision on whether to buy the invoice 310 at a discount. In at least some embodiments, this combined score is an average of the individual scores of the seller 135 and the payer 120. In other embodiments, this combined score is weighted towards one of the seller 135 or the payer 120. In at least one embodiment, the Altman Z-score is used in addition to other risk factoring information for the seller 135 and/or the payer 120, such as risk associated with a particular market and industry sector, size of the invoice 310, and any other information, such as an Artificial Intelligence (AI) based Risk Assessment engine 446 shown in FIG. 4, that provides risk analysis information. The Altman Z-score is the output of a rating-strength test that gauges a publicly traded manufacturing company's likelihood of bankruptcy. The Altman Z-score is based on five financial ratios that can be calculated from data found on a company's annual 10K report. It uses profitability, leverage, liquidity, solvency and activity to predict whether a company has a high degree of probability of being insolvent.

The Altman Z-score calculation formula is as follows:

Z-score=1.2X₁+1.4X₂×3.3X₃+0.6X₄+0.999X₅

where:

X₁—Working capital/total assets;

X₂—Retained earnings/total assets;

X₃—Earnings before interests and taxes/total asset;

X₄—Market value of equity/total liabilities; and

X₅—Sales/total assets.

In at least one embodiment, the SIPRA 165 extends or replaces Altman Z-score calculation formula with additional data points or a proprietary formula. In at least one embodiment, the Altman Z-score calculation formula is used in combination with this proprietary formula (e.g., an average of the two scores, weighted scores, etc.). For example, the SIPRA 165 includes more data points sourced from at least one of the local database 170, the private blockchain 175 and public blockchain 190, the corporate intelligence sources 145, and by using training set and Machine Learning algorithms to improve risk calculation and assessment of the seller 135 and the payer 120 by finding more measuring points and related weights. Such an extended or proprietary formula includes a seller 135 score and a payer 120 score based on data available on the local database 170, private blockchain 175, public blockchain 190, and third-party data providers (e.g. corporate intelligence sources 145), with defaulted invoices 310 and delays on payment of the invoices 310 also being adding to the scoring of the seller 135, which is based on seller 135 defaults and seller 135 delays in paying invoices 310. In at least one embodiment, the SIPRA 165 invokes blocking rules in response to defaults on payments of the invoices 310, by either the buyer 115 and the payer 120. All these additional data are available through data collection on the local database 170, private blockchain 175, public blockchain 190 and third-party data providers (e.g. corporate intelligence sources 145).

Following is a formula for calculating a seller 135 score:

SIPRAScore=AX₁+BX₂+CX₃+DX₄+EX₅+FX₆+GX₇

where:

X₁—Working capital/total assets

X₂—Retained earnings/total assets

X₃—Earnings before interests and taxes/total assets

X₄—Market value of equity/total liabilities

X₅—Sales/total assets

X₆—Score of the company (defaults & delays in paying their invoices)

X₇—Score of company's buyers (all buyer's defaults & delays in paying their invoices)

Following is the list of data points (i.e., seller criteria) that can be used:

Current Assets

Current Liabilities

Working Capital

Retained Earnings

Earnings Before Interest and Taxes

Total Liabilities

Total Assets

Gross Sales

In at least one embodiment, the rating score of the seller 135 is calculated based on at least one seller 135 criteria including at least one of social media rating, liquidity, payment discipline, court proceedings, corporate intelligence information from one or more corporate intelligence sources 145, and any other seller criteria that provides the buyer 115 with information needed to make an informed purchase. In some countries there are feeds available with corporate annual financial information and corporate intelligence 145. In at least one embodiment, the SIPRA 165 imports data from those feeds and stores these in a persistent storage, such as the local database 170.

FIG. 2 illustrates example function modules of the SIPRA 165, in accordance with the embodiments disclosed herein. The SIPRA 165 includes an Administration module 210. The Administration module 210 includes an Account Approval module 212. For new account users/companies will apply for new account. As part of the new account creation, KYC validation is performed and the new account users/companies will need to review and legally agree to account terms. Once all conditions are satisfied, an administrator 205 will approve a new account. In at least one embodiment, a tier approach can be implemented where users have different privilege based on the approved tier. For example, a new account without any agreement to account terms in place can only review an Invoice Marketplace in which invoices 310 are listed for sale. The Administrator module 210 further includes an Account Management module 214. The administrator 205 has an ability to put any account on hold, to review any feedbacks and/or complaints, etc., via the Administrator module 210. The Administration module 210 further includes a Dashboard module 216. The Dashboard module 216 enables the administrator 205 to review financial holdings of the ecosystem, review financial status, transfer any funds in and out of the SIPRA digital wallet 215 containing the proprietary tokens of the SIPRA 165, view account activities, etc.

The administrator 205 further accesses the Fund Management module 290. The Fund Management module 290 includes a Deposit Management module 291 and a Withdrawal Management module 292, the Fund Management module 290 having access to the Financial Institution 160. The administrator 205 accesses the Fund Management module 290 to manage fund deposits to/from the Financial Institution 160 via the Deposit Management module 291 and a Withdrawal Management module 292, respectively.

The SIPRA 165 further includes a Registration module 220. The Registration module 220 includes an Account Registration module 222. In order to start using services provided by the SIPRA 165 a user will need to register. In order to register for a new account, the user will need to provide information, such as a first name, last name, company name, contact phone number, contact email address, and company number. In at least one embodiment, the list will be country by country dependent. In at least one embodiment, the user's email address will need to have the same domain as a corporate website. In at least one embodiment, once an account is approved the user can setup two factor authentication for logins. The Registration module 220 further includes an Account Configuration module 224. The Account Configuration module 224 allows the user to setup the SIPRA digital wallet 215, language preferences, communication preferences, etc. The Registration module 220 further includes a KYC Functionality module 226. All parties that register with the SIPRA 165 will need to provide documentation in order for the SIPRA 165 to comply with KYC policy. Such documentation can be submitted via the KYC Functionality module 226.

In an example, the Registration module 220 further includes a Tier User Account Verification module (not shown). The Tier User Account Verification module provides for Issuer Account Verification, Debtor Account Verification, and Investor Account Verification. In at least one embodiment, buyers 115 are verified through a tier verification process. For example, an example Tier 1 includes being able only to view a list of available invoices 310 (issuer and debtor are encrypted) (user name, password, email validation). An example Tier 2 includes being able to transfer and withdraw up to $1000 a week (phone validation). An example Tier 3 includes being able to transfer and withdraw up to $10,000 a week and being able to see who is an issuer (Driver License or Passport or Personal ID with picture and utility bill or bank address confirmation). An example Tier 4 includes being able to transfer and withdraw up to $100,000 a day and being able to see all invoice related data which includes issuer and debtor.

The SIPRA 165 further includes an Invoice Management module 240. The Invoice Management module 240 includes an Add Invoice module 241. The Add Invoice module 241enables users to add new invoices 310. In at least one embodiment, an Enterprise Resource Planning (ERP) plugin is used for adding the invoices 310 to the SIPRA 165. Different ERP plugins can be used for different ERP systems, which enables easy publishing of the invoices 310 on the private blockchain 175 and the public blockchain 190. In at least one embodiment, the ERP enables easy migration after a sale of the invoice 310 is executed. In at least one embodiment, access to add new invoices 310 is provided by an application (e.g., a Web application, a decentralized application (DAPP), and/or any other type application that provides access to add new invoices 310). The Invoice Management module 240 further includes a Push Invoice OnSale module 242, a Select Type of Invoice Factoring module 243, an Update Invoice Status module 244, a Provide Investor with ability to see Invoice Details module 245, and an Upload Monthly Financial Statement module 246.

The SIPRA 165 further includes a Login module that includes a User Login module, a Forgotten Password module, and a Setup 2FA module. The SIPRA 165 further includes a Security module that includes an Integration with Ledger Nano & Ledger Blue module and an Integration with Trezor module. The SIPRA 165 further includes a Financial Data module that includes a Push Monthly Financial Report module and a Push Annual Financial Report module. The SIPRA 165 further includes a Rating module that includes a Rating Generator module 265 generating the rating scores described herein and a Third-Party Source Management module. The SIPRA 165 further includes a Feed Management module that includes a Feed Integration module, a Data Load module, and a Feed Scheduling module.

The SIPRA 165 further includes an Investment Management module 250 that includes a Browse Invoice Market module 251, a List All Bid Invoices module 256, a List All Owned Invoices module 257, an Invoice for Sale module 258, a Send Offer module 252, a Transfer Funds module 253, a Transfer Ownership module 254, a Request to See Invoice Details module 255, and a Transaction History module 259. The Investment Management module 250 accesses the buyer's 115 digital wallet 277, which can hold funds such as ERC20 compliant tokens, stable ERC20 internal tokens, Ethereum tokens, Bitcoin tokens, and/or any other funds. In an example, the buyer's 115 digital wallet 277 of the buyer 115 can hold cryptocurrency, such as Bitcoin and/or Ethereum. The benefits of Ethereum include full transparency and a lack of need for a production environment.

The Investment Management module 250 is further coupled to financial institutions 160. In an example, the Investment Management module 250 is coupled to the financial institutions 160.

The Browse Invoice Market module 251 enables a buyer 115 to browse and filter the Invoice Marketplace for available invoice factoring opportunities. Information that is available for buyers 115 to review is as follows: seller 135 of the invoice 310, invoice 310 identification, date of invoice 310 creation, invoice 310 amount, rating of seller 135, payer 120 of the invoice, date sale offer expires, due date of the invoice 310, takeover amount for the invoice 310, the type of industry associated with the invoice 310, and if the invoice 310 is verified. In at least one embodiment, the following information is not available for the buyers 115, for example can be blurred out, such as a name of the seller 135 and a name of the buyer 115.

The fields that are by default available to the buyer 115 are as follows:

Invoice 310 Identification—a SIPRA 165 based invoice 310 Identification that is unique identifier for a particular invoice 310;

Creation Date of the invoice 310;

Due Date of the invoice 310;

Original invoice 310 amount;

Takeover amount—in the case that invoice 310 is sold for a fix price;

Offer expiry date—expiry date for selling the invoice 310;

Rating—rating score of the seller 135 that is selling the invoice 310 and the payer 120 that pays on the invoice 310;

Verified—the invoice 310 has been confirmed by the buyer 115 side.

The SIPRA 165 provides functions for the buyer 115 as follows:

Buy It—this functional option enables the buyer 115 to create an offer in order to take over the invoice 310; and

See All—this request is sent to Invoice Originating Company in order to see Invoice Originating Company name and Buyers Company name. The Invoice Originating Company can choose to enable the buyer 115 to see the info, for example, for limited amount of time.

The administrator 205 accesses the Account Management module 214 and the Dashboard module 216. The payer 120 accesses the Registration module 220, the Login module, and the Invoice Management module 240. The Login module accesses the Security module. The Rating module accesses the Invoice Management module 240. The seller 135 accesses the Registration module 220, the Login module, Invoice Management module 240, and the company digital wallet 267. In an example, the company digital wallet 267 can hold funds such as ERC20 compliant tokens, stable ERC20 internal tokens, Ethereum tokens, Bitcoin tokens, and/or any other funds. The buyer 115 accesses the Registration module 220, the Invoice Management module 240, and the Investment Management module 250.

The Send Offer module 252 provides buyers 115 with different offer forms. Such offer forms include:

1. Form with offer amount plus cost of the ownership change in tokens of the SIPRA 165, such as stored in the company digital wallet 267. This form has confirmation and cancellation function.

2. In the case where the invoice 310 is available for bid, buyer 115 will be presented with an amount field and will be able to see a highest bid. The buyer 115 is visually presented with information if he/she is the highest bidder, or not, and give an option to bid. Also, the buyer 115 is presented with an auto bid option in which the buyer 115 can specify a highest amount willing to pay and the SIPRA 165 will automatically bid for the buyer 115.

3. In the case when the price of the invoice 310 linearly increases based on time (f(time)=price*timeFactor), this form is going to be similar as for case number 1 above except that a minimum value price changes over the time.

The Transfer Funds module 253 allows the buyer 115 to take over ownership of the invoice 310. In order for the buyer 115 to take over ownership of the invoice 310, he/she will need to send funds to the seller 135 of the invoice 310. Options available for transferring funds include:

1. Buyer 115 pays the seller 135 of the invoice 310 by transferring value to the seller 135, such as with Bitcoin, Ethereum, and/or tokens from the SIPRA digital wallet 215.

2. Buyer 115 pays the seller 135 of the invoice 310 by transferring fiat funds to the seller 135.

The Transfer Ownership module 254 updates ownership of the invoice 310. Once the SIPRA 165 has received required funds, ownership of the invoice 310 gets updated by the SIPRA 165. The cost of purchase of the invoice 310 is included in required funds to buy the invoice 310. The Request to See Invoice Details module 255 allows the buyer 115, at any time, to request from the seller 135 of the invoice 310 to see invoice 310 details such as invoice 310 originator name and buyer name. The seller 135 of the invoice 310 must give their permission to the buyer 115 to see the information for a limited (specified) time. The List All Bid Invoices module 256 allows the buyer 115 to review a list of all invoices 310 that are currently being bid on and a status of each of them. A visual indication is provided to the buyer 115 if a buyer 115 bid is the highest or not and also allows buyer 115 to increase the offer. If a new offer is not higher than the highest offer, the List All Bid Invoices module 256 rejects this new offer.

The List All Owned Invoices module 257 allows the buyer 115 to see a list of all their own invoices. Data of this list includes invoice 310 identification, date the invoice 310 was created, the due date of the invoice 310, the invoice 310 amount, the purchase price of the invoice 310, and the profit to be made from the invoice 310. In at least one embodiment, the seller 135 of the invoice 310 and the payer 120 of the invoice 310 are not visible.

The Invoice for Sale module 258 provides the buyer 115 with ability to find all the invoices 310 that are currently on sale and to put an offer to the seller 135 of the invoice 310 to buy the invoice 310. The Invoice for Sale module 258 provides a visual differentiation on the invoices 310 that the buyer 115 has put in an offer on and also in the case of bidding, if the bid of the buyer 115 is highest or not. The Transaction History module 259 provides a historical report that enables buyers 115 to see all past transactions, cost, profits and losses.

The SIPRA 165 further includes a Notification Engine module 280 that includes an Email notification module 281, an SMS notification module 285, and an inApp notification module 288. The SIPRA 165 sends out notifications of events via such modules 281/285/288, such as short message service (SMS) messages, email messages, or any other messages, providing the administrator 205, the payer 120, the seller 135, and the buyer 115 with event information, such as sales, offers, account changes, etc., associated with their respective accounts and invoices 310.

FIG. 3 illustrates example high level interaction 300 between the seller 135, the payer 120, and the buyer 115 each using the SIPRA 165, in accordance with the embodiments disclosed herein. In particular, in an example step 1 the seller 135 sends an invoice, via the SIPRA 165, to the payer 120 to confirm an outstanding debt associated with the invoice 310. In response in an example step 2, the payer 120 confirms, via the SIPRA 165, the debt associated with the invoice 310. The seller 135 desires to sell the invoice to another party and therefore lists in an example step 3 the invoice for sale on the SIPRA 165. In response to such a listing, in an example step 4 the buyer 115 sends an offer, via the SIPRA 165, to take over ownership of (e.g., buy) the invoice. Should the seller 135 accept the offer to takeover ownership of the invoice 310, in an example step 5 the SIPRA 165 changes the ownership of the invoice 310 to the buyer 115. The sale, including the seller 135, the buyer 135, and in at least one embodiment the payer 120, is recorded by the SIPRA 165 on the private blockchain 175 and/or the public blockchain 190. In an example step 6, the payer 120 pays the buyer 115 on the invoice 310. In an example, the payer 120 pays the buyer 115 in ERC20 compliant tokens. Such payment is recording by the SIPRA 165 on the private blockchain 175 and/or the public blockchain 190. In at least one embodiment, a company registered on the SIPRA 165 can view two portfolios, its own invoice 310 receivables, that are or could be offered for sale and invoice 310 payables, such as invoices 310 that are listed by other sellers 135 where the company is the payer 120. The company in this scenario can act as the buyer 115 and purchase their invoice payables, using reverse invoice financing features.

The administrator 205 is able to view system reports, and manage accounts and system configuration. The API enables upload of the invoices 310 through a programmable interface. The seller 135 can create invoices 310, sell invoices 310, and review an archived invoice 310, all on the SIPRA 165. The payer 120 can approve received invoices 310, dispute invoices 310, and view archive of past received invoices 310. The buyer 115 is able to view all invoices 310 that are available for takeover, create an offer for takeover, send required funds for takeover, view and sell invoices 310 that the buyer 115 owns, reporting on investment performance, etc.

FIG. 4 illustrates an example high level architecture 440 of the SIPRA 165 shown in FIG. 1, in accordance with the embodiments disclosed herein. The high-level architecture 440 is comprised of a private blockchain 410 that includes a smart contract for tracking assets 411, shown as “Treasury”, a smart contract representing invoice and ownership 412, shown as “Invoice”, and an escrow smart contract 413, shown as “Escrow”, to ensure that ownership transfer is completed at the same time as a financial transfer related to the effected invoice 310 occurs. The high-level architecture 440 further includes a public blockchain network 420. The public blockchain network 420 includes an auditor smart contract 421, shown as “Auditor”, that insures that SIPRA 165 is not compromised, and a Smart Contract 422 that stores as Merkle tree hash of the private blockchain 410. Although the private blockchain 410 and the public blockchain 420 are shown as being part of the high-level architecture 440, in other embodiments one of the private blockchain 410 and the public blockchain 420 are not part of the high-level architecture 440. In an example, the SIPRA 165 uses an Ethereum based private blockchain module 410 and an Ethereum based public blockchain module 420, although other types of blockchain modules other than Ethereum are possible for the private blockchain module 410 and/or public blockchain module 420.

The high level architecture 440 is further comprised of an Authentication and Authorization module 441 that grants account management for users accessing the SIPRA 165, such as the buyers 115, the sellers 135, the payers 120, finance (e.g., financial institution 160), and support (e.g., administrator 205), a KYC/AML module 442 that provides tools for support and integration with third party software, an Invoice life cycle management, an Offer management and Ownership change Management module 443 that provides the basis services of the SIPRA 165 for buying, and selling the invoices 310, and in at least some embodiments assigning the invoices 310, shown as “Market Place/Invoice Sell/Invoice Takeover”, a Management of Funds module 444, shown as “Ledger”, for all of the accounts on the SIPRA 165, and a Minting, Burning and Assignments of Tokens module 445, shown as “Token Mint/Burn”, for individual accounts on the SIPRA 165. The Minting, Burning and Assignments of Tokens module 445 mints tokens in a same amount of money/crypto that the buyer 115 uploads to their wallet 277. Such minted tokens are used for invoice takeover (i.e., ownership transfer) and are burnt after the seller 135 withdraws money/payment for the assigned invoice 310, also discussed above.

The high level architecture 440 is further comprised of the AI based Risk Assessment engine 446 that calculates an invoice score based on a company rating module 447 that tracks financial behavior associated with particular companies and generates a rating score for particular companies (e.g., for use in obtaining bank credit, etc.), an invoice rating module 448 that rates particular invoices 310 based on a combination of a company rating for both the seller 135 and the payer 120, a Reputation Management module 449 that tracks behavior of payers 120 inside the SIPRA 165 network and outside the SIPRA 165 network through data feeds, such as newsfeeds, legal proceedings, etc., and produces a company reputation score, and a Preference Centre 450 that allows every account holder to set their own profile and preferences so that information presented on their displays 125 are tailor to their needs. AI used by the AI based Risk Assessment engine 446 is used to create more accurate ratings for the seller 135 and the payer 120.

The high level architecture 440 is further comprised of a Treasury module 451 responsible for tracking and consolidation of available assets, including reporting for the users accessing SIPRA 165, such as the buyers 115, the sellers 135, and the payers 120, a Data Feeds module 452 responsible for integration and aggregation of external data feeds related to company information for the sellers 135 and the payers 120, including financial health of particular companies, political exposure of owners of particular companies, legal actions against particular companies, media news related to particular companies, etc., as a basis for generating the ratings described herein, and a Crypto Exchange API 456 to accurately calculate a cost of the transactions, such as a daily average of crypto currency obtained on a daily basis.

The high-level architecture 440 is further comprised of a RESTful API and a Web module. The RESTful API allows communication with the SIPRA 165 from other applications. The RESTful API allows an ERP system 470 to upload invoices and, in at least some embodiments, mobile apps executing on a mobile device 480 to talk to a back end of the SIPRA 165.

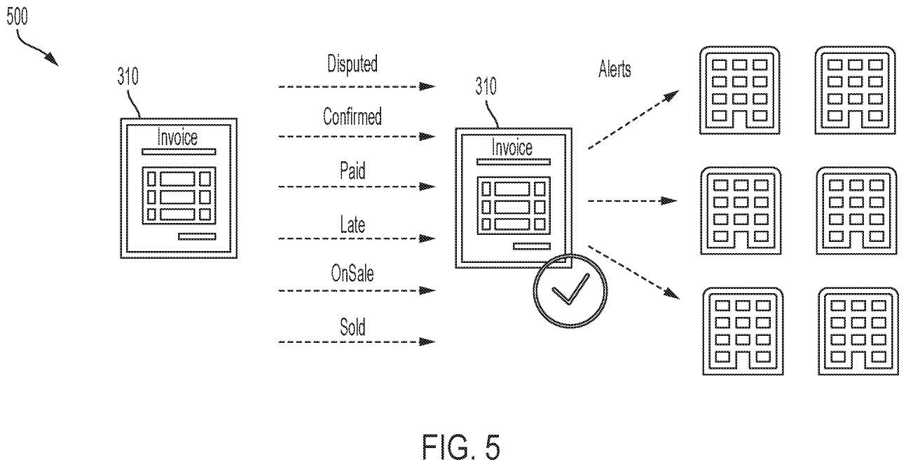

FIG. 5 illustrates example actions that are available to be performed on the invoices 310, in accordance with the embodiments disclosed herein. The invoice 310 can include various information, such as an issuing and paying company name, company address, company VAT number, company legal number, customer name, customer address, invoice creation date, invoice due date, invoice amount, and invoice currency. The actions that can be performed on the invoice 310 include disputed, confirmed, paid, late, OnSale, sold. Any of these actions can generate alerts to one or more entities, such as the buyer 115, seller 135, and/or payer 120, designated to receive such alerts. Such one or more entities can be stored by the SIPRA 165.

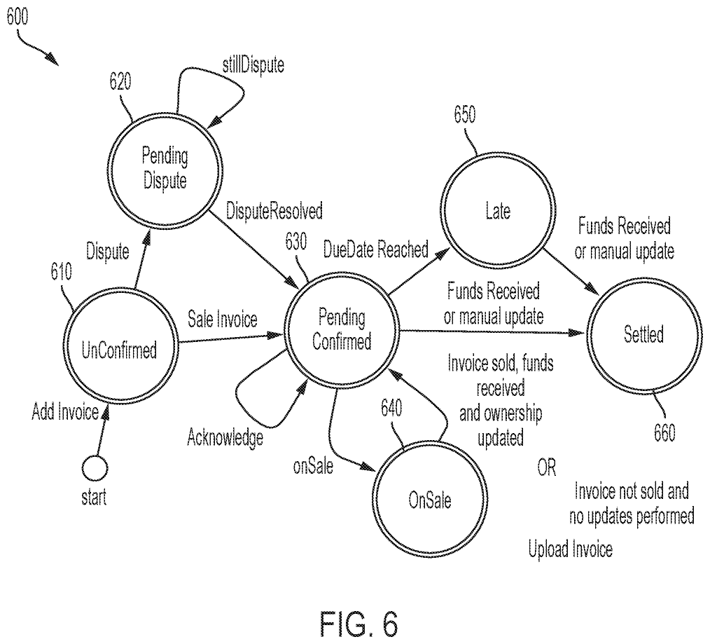

FIG. 6 illustrates an example invoice lifecycle 600, such as example processes performed by the SIPRA 165, in accordance with the embodiments disclosed herein. The invoice that a seller 135 wants to sell is added to the SIPRA 165, shown as a status of Unconfirmed 610. Once the invoice 310 is published its initial state is UnConfirmed 610. Depending upon if the invoice is disputed or the invoice 310 is sold, the invoice status is changed to Pending Dispute 620 and Pending Confirmed 630, respectively. The status of Pending Dispute 620 is checked again and if the Pending Dispute 620 remains unchanged, the status loops back to Pending Dispute 620. If the status is dispute resolved, the status of the invoice 310 is changed from Pending Dispute 620 to Pending Confirmed 630.

The status of Pending Confirmed 630 changes to OnSale 640 if the invoice 310 is uploaded for sale, that is OnSale. The status of OnSale 640 is changed back to Pending Confirmed 630 once the invoice 310 is sold, funds are received, and ownership is updated. The status changes from Pending Confirmed 630 to Late 650 if a due date for payment from the payer 120 has elapsed without the payer 120 making payment on the invoice 310. The status of both Late 650 and Pending Confirmed 630 is changed to Settled 660 if either the funds are received by the buyer 115 from the payer 120 or a manual update is made to the status of the invoice 310. In an example, the Pending Confirmed 630 continues to check for an acknowledgement that the invoice 310 status remains resolved.

Once the invoice 310 is confirmed by the seller 135, the invoice 310 will potentially go through example states. Pending invoices 310 are invoices 310 that are waiting to receive payment and can potentially be sold but are not. Pending invoices 310 can have a confirmed state and an unconfirmed state. When the invoice 310 is created and sent to the seller 135, the status of the invoice 310 is pending unconfirmed. Once the seller 135 acknowledges the invoice 310, the invoice 310 changes state to confirmed. OnSale invoices are those that seller 135 wants to sell in order to receive payment sooner than the due date on the invoice 310. Settled invoices 310 are those for which the seller 135 has already received payments, either from the buyer 115 or by selling it.

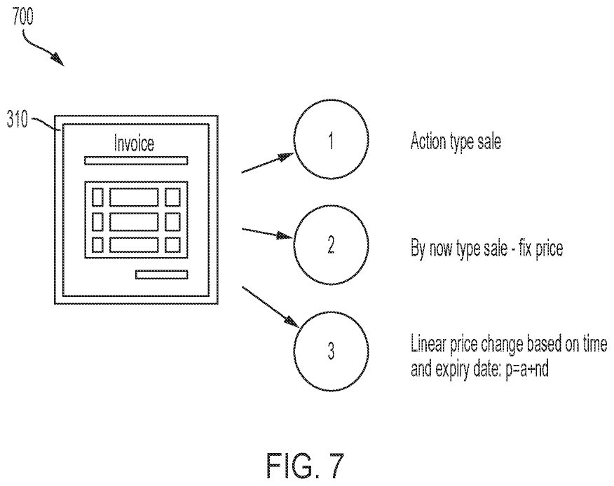

FIG. 7 illustrates example sell options 700 available to the seller 135, such as a company, of an invoice 310, in accordance with the embodiments disclosed herein. When the seller 135 decides to sell the invoice 310, the seller 135 is asked to select which kind of sell options to use. The sell options 700 include an example option 1 to sell an invoice for a fixed price during a defined amount of time. In at least one embodiment, this option has a business rule that will compare the sell price with a market dictated discount amount, and the sell price cannot be higher than the market dictated discount amount. The sell options 700 further include an example option 2 to sell the invoice on auction, with buyer 115 able to bid on the invoice, during a defined amount of time. The sell options 700 further include an example option 3 to sell the invoice during a specified time based on linear regression, with maximum discount at the beginning of the specified time and minimum discount at the end of specified time. For example, the discount decreases as a current time nears when payment is due on the invoice 310.

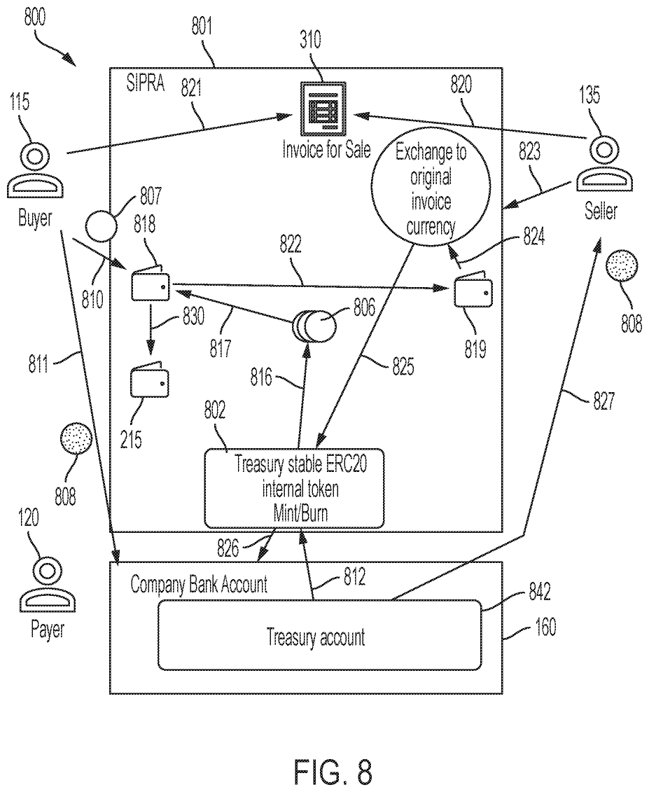

FIG. 8 illustrates an example flow of funds to/from the SIPRA 165, in accordance with the embodiments disclosed herein. When the buyer 115 uploads funds to the SIPRA 165, the buyer 115 sends, at 808, market currency to a specified financial institution's 160 treasury account 842. The treasury account 842 notifies, at 812, a SIPRA 165 treasury block 802 to mint, at 816, internal ERC20 crypto tokens 806. The SIPRA 165 treasury block 802 is an internal token treasury that is not available outside the SIPRA 165. Newley minted tokens 806 get uploaded, at 817, to an owner's internal crypto wallet, such as the internal digital crypto wallet 818. The buyer 115 uploads 810 ERC20 compliant crypto tokens 807 to the digital crypto wallet 818. At 820, the seller 135 puts the invoice 310 up for sale.

The seller 135 publishes via the SIPRA 165 the invoice 310 for sale that has been previously verified by the payer 120 of the invoice 310. The buyer 115 of the invoice 310 buys, at 810, the invoice 310. The internal ERC20 tokens 806 get transferred from buyer's 115 internal digital crypto wallet 818 to seller's 135 internal digital crypto wallet 819. The buyer 115 of the invoice 310 gets charged for beneficiary update on the invoice 310 and funds get transferred, at 830, from the buyer's 106 digital wallet 277, at 816 to the SIPRA digital wallet 215, at 831.

The seller 135 withdrawals funds by initiating withdrawal of funds, at 823. Funds from seller's 135 internal crypto wallet 819 gets transferred, at 825, to the SIPRA treasury block 802 for processing. The SIPRA treasury block 802 freezes a requested amount of funds and sends a request, at 826, to the financial institution 160 for fund transfer, at 827 to the seller 135 of the invoice 310. Upon confirmation of fund transfer completion, SIPRA treasury block 802 burns the funds that were frozen for the specific seller 135. This process performs transformation of internal stable ERC20 crypto tokens 806 to original monetary currency 808 of the invoice 310, such as that transferred to the SIPRA 165 at 820.

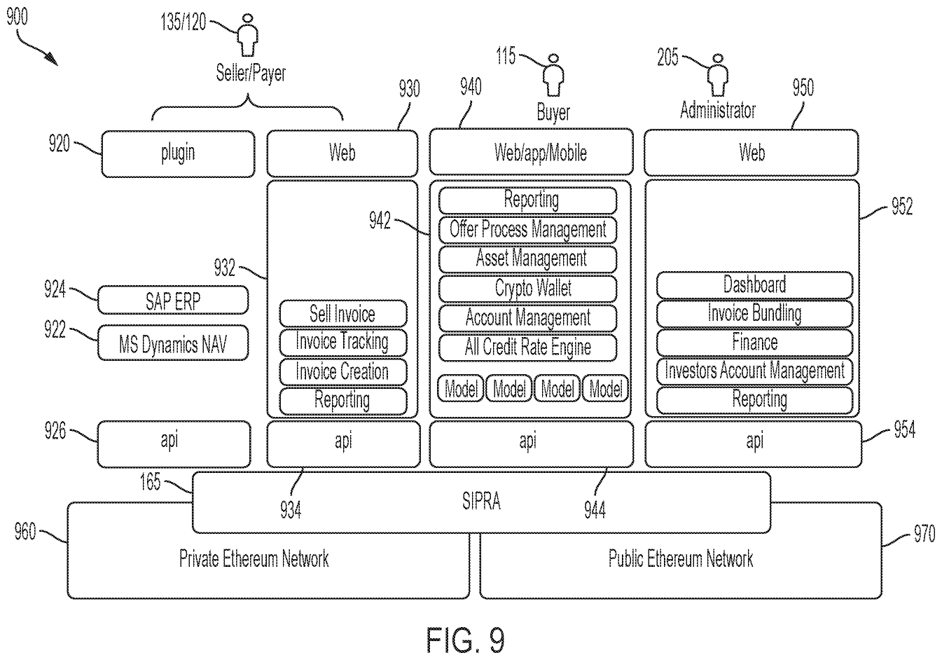

FIG. 9 illustrates an example high level architecture 900 including the SIPRA 165 for buying and selling the invoices 310, in accordance with the embodiments disclosed herein. In this example, the SIPRA 165 is built upon private and public blockchains, such as the Private Ethereum Network 960 and the Public Ethereum Network 970.

The seller 135 and payer 120 access the services of the SIPRA 165 via at least one of a plugin 920 and a webpage 930, such as via the communication network 140. The plugin 920 is for Microsoft Dynamics NAV 922 and/or for Systems Applications and Products (SAP) ERP 924. The SIPRA 165 interfaces with the Microsoft Dynamics NAV 922 and/or for SAP ERP 924 via an API 926. Although the API 926 is illustrated as interfacing with the Microsoft Dynamics NAV 922 and/or for SAP ERP 924, the API 926 is able to interface with any ERP system. Likewise, the seller 135 and payer 120 access a seller/payer services application 932 for selling services, invoice tacking services, invoice creation services, and reporting services. The SIPRA 165 interfaces with the application 932 via an API 934.

The seller 135 access the services of the SIPRA 165 via an application, such as app 940. The app 940 interfaces with an application 942 for reporting. The SIPRA 165 interfaces with an application 942 via an API 944. The administrator 205 accesses the application 942 for reporting services, offer process management services, asset management services, access to the SIPRA digital wallet 215, account management services, credit scoring engine services, and various model services.

The administrator 205 accesses the services of the SIPRA 165 via the webpage 950, such as via the communication network 140. The administrator 205 accesses a webpage 950 for accessing administrative services 952, such as dashboard services, invoice bundling services, finance services, buyer 115 account management services, and reporting services. The SIPRA 165 interfaces with the administrative services 952 via an API 954.

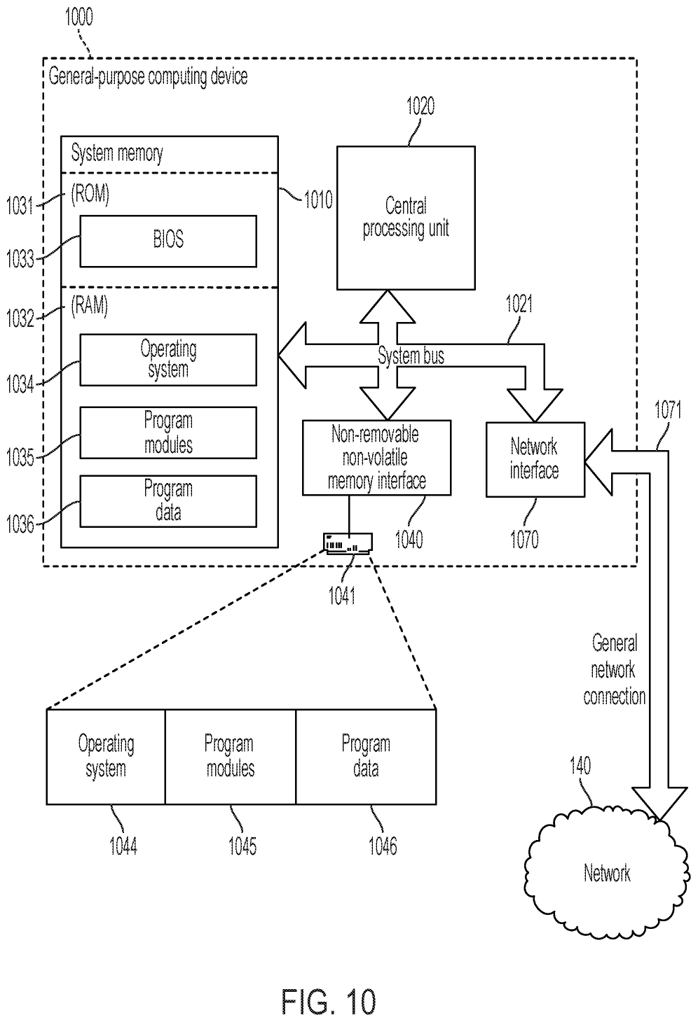

With reference to FIG. 10, the exemplary general-purpose computing device is illustrated in the form of an exemplary apparatus, such as a general-purpose computing device 1000. The general-purpose computing device 1000 may be of the type utilized for the UE 130 (FIG. 1), the financial institution 160 (FIG. 1), the SIPRA 165 (FIG. 1), the corporate intelligence source 145, as well as any of the other computing devices in the system 100 and with which the SIPRA 165 may communicate through the communication network 140 (FIG. 1). In at least one embodiment, the general-purpose computing device 1000 is a distributed computing device. As such, it will be described with the understanding that variations can be made thereto. The exemplary general-purpose computing device 1000 can include, but is not limited to, one or more central processing units (CPUs) 1020, such as the processor 180, a system memory 1030 and a system bus 1021 that couples various system components including the system memory 1030 to the CPU 1020. The system bus 1021 may be any of several types of bus structures including a memory bus or memory controller, a peripheral bus, and a local bus using any of a variety of bus architectures. Depending on the specific physical implementation, one or more of the CPUs 1020, the system memory 1030 and other components of the general-purpose computing device 1000 can be physically co-located, such as on a single chip. In such a case, some or all of the system bus 1021 can be nothing more than communicational pathways within a single chip structure and its illustration in FIG. 10 can be nothing more than notational convenience for the purpose of illustration.

The general-purpose computing device 1000 also typically includes computer readable media, which can include any available media that can be accessed by the general-purpose computing device 1000. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the general-purpose computing device 1000. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

When using communication media, the general-purpose computing device 1000 may operate in a networked environment via logical connections to one or more remote computers. The logical connection depicted in FIG. 10 is a general network connection 1071 to the communication network 140, which can be a local area network (LAN), a wide area network (WAN) such as the Internet, or other networks. The general-purpose computing device 1000 is connected to the general network connection 1071 through a network interface or adapter 170 that is, in turn, connected to the system bus 1021. In a networked environment, program modules depicted relative to the general-purpose computing device 1000, or portions or peripherals thereof, may be stored in the memory of one or more other computing devices that are communicatively coupled to the general-purpose computing device 1000 through the general network connection 1071. It will be appreciated that the network connections shown are exemplary and other means of establishing a communications link between computing devices may be used.

The general-purpose computing device 1000 may also include other removable/non-removable, volatile/nonvolatile computer storage media. By way of example only, FIG. 10 illustrates a hard disk drive 1041 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM 1032, solid state ROM 1031, and the like. The hard disk drive 1041 is typically connected to the system bus 1021 through a non-removable memory interface, such as interface 1040.

The drives and their associated computer storage media discussed above and illustrated in FIG. 10, provide storage of computer readable instructions, data structures, program modules and other data for the general-purpose computing device 1000. In FIG. 10, for example, hard disk drive 1041 is illustrated as storing operating system 1044, other program modules 1045, and program data 1046. Note that these components can either be the same as or different from operating system 134, other program modules 1035 and program data 136. Operating system 1044, other program modules 1045 and program data 1046 are given different numbers here to illustrate that, at a minimum, they are different copies.

With reference to FIG. 1, again, the foregoing description applies to the system 100 for buying and selling invoice(s) 310, as well as to any other computing devices in communication with the system 100 through the communication network 140. The CPU 1020 is coupled to the network interface 1070, such as the transceiver 185. The network interface 1070 facilitates outside communication in the form of voice and/or data. For example, the communication module may include a connection to a Plain Old Telephone Service (POTS) line, or a Voice-over-Internet Protocol (VOIP) line for voice communication. In addition, the network interface 1070 may be configured to couple into an existing network, through wireless protocols (Bluetooth, 802.11a, ac, b, g, n, or the like) or through wired (Ethernet, or the like) connections, or through other more generic network connections. In still other configurations, a cellular link can be provided for both voice and data (i.e., GSM, CDMA or other, utilizing 2G, 3G, and/or 4G data structures and the like). The network interface 1070 is not limited to any particular protocol or type of communication. It is, however, preferred that the network interface 1070 be configured to transmit data bi-directionally, through at least one mode of communication. The more robust the structure of communication, the more manners in which to avoid a failure or a sabotage with respect to communication, such as to communicate an audio segment(s) in a timely manner.

The SIPRA 165 comprises a user interface which can configure the UE 130, and the UE 130 comprises a user interface which can configure the SIPRA 165. In many instances, the SIPRA 165 and/or the UE 130 comprise a keypad and a display that is connected through a wired connection with the CPU 1020. The SIPRA 165 and the UE 130 can participate in the blockchain based invoice sales disclosed herein, either with limited functionality (e.g., smart watch, smart speaker) or full functionality (e.g., smart television, personal computer). Of course, with the different communication protocols associated with the network interface 1070, the network interface 1070 may comprise a wireless device that communicates with the communication network 140 through a wireless communication protocol (i.e., Bluetooth, RF, WIFI, etc.). In other embodiments, the social networking platform 1012 may comprise a virtual programming module in the form of software that is on, for example, a smartphone, in communication with the network interface 1070. In still other embodiments, such a virtual programming module may be located in the cloud (or web based), with access thereto through any number of different computing devices. Advantageously, with such a configuration, a user may be able to communicate with the system 100 remotely, with the ability to change functionality.

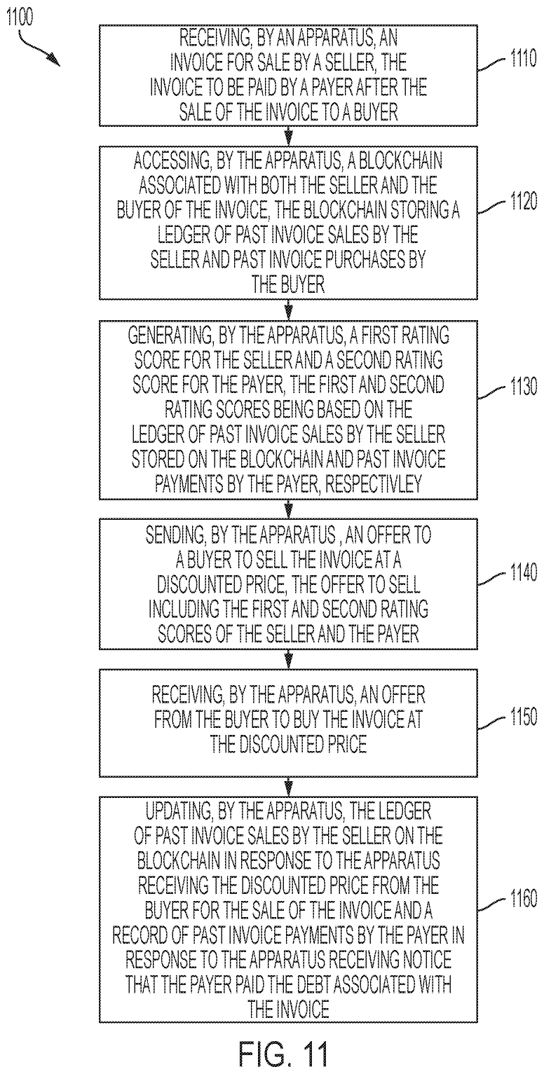

FIG. 11 illustrates an example flowchart for a method 1100 of buying and selling invoices, in accordance with the embodiments disclosed herein. At block 1110, the method 1100 includes receiving, by an apparatus such as the SIPRA 165, an invoice 310 for sale by the seller 135. This invoice 310 is to be paid by the payer 120 after the sale of the invoice 310 to the buyer 115. Block 1110 proceeds to block 1120. At block 1120, the method 1100 further includes accessing, by the apparatus, a blockchain, such as the private blockchain 175, associated with both the seller 135 and the buyer 115 of the invoice 310, the private blockchain 175 storing a ledger of past invoice sales by the seller 135 and past invoice purchases by the buyer 115. Block 1120 proceeds to block 1130.

At block 1130, the method 1100 further includes generating, by the apparatus, a first rating score for the seller 135 and a second rating score for the payer 120, the first and second rating scores being based on the ledger of past invoice sales by the seller 135 stored on the private blockchain 175 and past invoice payments by the payer 120, respectively. Block 1130 proceeds to block 1140. At block 1140, the method 1100 further includes sending, by the apparatus, an offer to the buyer 115 to sell the invoice 310 at a discounted price, the offer to sell including the first and second rating scores of the seller 135 and the payer 120. Block 1140 proceeds to block 1150. At block 1150, the method 1100 further includes receiving, by the apparatus, an offer from the buyer 115 to buy the invoice at the discounted price. Block 1150 proceeds to block 1160. At block 1160, the method 1100 further includes updating, by the apparatus, the ledger of past invoice sales by the seller 135 on the private blockchain 175 in response to the apparatus receiving the discounted price from the buyer 115 for the sale of the invoice 310 and a record of past invoice payments by the payer 120 in response to the apparatus receiving notice that the payer 120 paid the debt associated with the invoice 310. In at least one embodiment, this record is a database record that is stored on the SIPRA 165. In at least one other embodiment, this record is another ledger that is stored on at least one of the private blockchain 175 and the local database 170.

In at least one embodiment, the method 1100 further includes sending, by the apparatus, a confirmation to the seller 135 that the invoice 310 offered for sale has been received by the apparatus. In at least one embodiment, the method 1100 further includes transferring, by the apparatus, ownership of the invoice to the buyer 115. In at least one embodiment, the method 1100 further includes authenticating, by the apparatus, a login to the apparatus by the seller 135 and the buyer 115, the authenticating including a two-factor authentication. In at least one embodiment, the seller 135 of the method 1100 is a company providing at least one of goods and services, associated with the invoice 310. In at least one embodiment, the private blockchain 175 and/or 190 of the method 1100 includes both on-chain processing and off-chain processing.

In at least one embodiment, the rating score of the method 1100 is based on at least one of financial data associated from the seller 135 stored on the private blockchain 175, and financial information for the seller 135 from a third-party provider. In at least one embodiment, the rating score of the method 1100 is based on the Altman Z-score.

In at least one embodiment, the method 1100 further includes transferring, by the apparatus, payment from the buyer 115 to the seller 135 via at least one of Bitcoin, Ethereum, tokens associated with the apparatus, and fiat funds. In at least one embodiment, the method 1100 further includes at least one of selling the invoice 310 for a fixed price, selling the invoice 310 on an auction, and selling the invoice 310 during a specified time period based on linear regression with the discount decreasing as time nears the end of the specified time period.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A method, comprising:
receiving, by an apparatus, an invoice for sale by a seller, the invoice to be paid by a payer after the sale of the invoice to a buyer;
accessing, by the apparatus, a blockchain associated with both the seller and the buyer of the invoice, the blockchain storing a ledger of past invoice sales by the sellerand past invoice purchases by the buyer;
generating, by the apparatus, a first rating score for the seller and a second rating score for the payer, the first and second rating scores being based on the ledger of past invoice sales by the seller stored on the blockchain and past invoice payments by the payer, respectively;
sending, by the apparatus, an offer to the buyer to sell the invoice at a discounted price, the offer to sell including the first and second rating scores of the seller and the payer;
receiving, by the apparatus, an offer from the buyer to buy the invoice at the discounted price; and
updating, by the apparatus, the ledger of past invoice sales by the seller on the blockchain in response to the apparatus receiving the discounted price from the buyer for the sale of the invoice and a record of past invoice payments by the payer in response to the apparatus receiving notice that the payer paid the debt associated with the invoice.

2. The method according to claim 1, wherein the blockchain is a private blockchain, the method further comprising periodically synchronizing the private blockchain with a public blockchain.

3. The method according to claim 1, further comprising receiving at least one of government issued currency, cryptocurrency, and propriety tokens, from the buyer for the invoice.

4. The method according to claim 1, wherein the blockchain is one of a private blockchain and a public blockchain.

5. The method according to claim 1, further comprising calculating at least one of the first rating score and the second rating score based on uploaded financial statements uploaded by at least one of the seller and the payer, respectively.

6. The method according to claim 1, further comprising calculating at least one of the first rating score and the second rating score based the Altman Z-score calculation formula.

7. The method according to claim 1, further comprising:
calculating a combined rating score based the first rating score and the second rating score;
wherein the first and second rating scores of the offer include the combined rating score as a basis for the buyer to buy the invoice at the discounted price.

8. The method according to claim 7, further comprising weighting the combined score towards one of the seller and the payer.

9. The method according to claim 1, further comprising calculating the discounted price based on linear regression, with a maximum discount applied to the discounted price at a beginning of a specified time and a minimum discount applied to the discounted price at an end of the specified time.

10. The method according to claim 1, further comprising calculating the first rating score based on at least one seller criteria include assets, current liabilities, working capital, retained earnings, earnings before interest and taxes, total liabilities, total assets, gross sales, social media rating, liquidity, payment discipline, corporate intelligence information, and court proceedings.

11. An apparatus, comprising:
a transceiver to receive an invoice for sale by a seller, the invoice to be paid by a payer after the sale of the invoice to a buyer, and access a blockchain associated with both the seller and the buyer of the invoice, the blockchain storing a ledger of past invoice sales by the seller and past invoice purchases by the buyer; and
a processor to generate a first rating score for the seller and a second rating score for the payer, the first and second rating scores being based on the ledger of past invoice sales by the seller stored on the blockchain and past invoice payments by the payer, respectively;
wherein the transceiver further to send an offer to the buyer to sell the invoice at a discounted price, the offer to sell including the first and second rating scores of the seller and the payer and receive an offer from the buyer to buy the invoice at the discounted price; and
wherein the processor further to update the ledger of past invoice sales by the seller on the blockchain in response to the apparatus receiving the discounted price from the buyer for the sale of the invoice and a record of past invoice payments by the payer in response to the apparatus receiving notice that the payer paid the debt associated with the invoice.

12. The apparatus according to claim 11, wherein the blockchain is a private blockchain, the processor to further periodically synchronize the private blockchain with a public blockchain.

13. The apparatus according to claim 11, the transceiver further to receive at least one of government issued currency, cryptocurrency, and propriety tokens, from the buyer for the invoice.

14. The apparatus according to claim 11, wherein the blockchain is one of a private blockchain and a public blockchain.

15. The apparatus according to claim 11, the processor further to calculate at least one of the first rating score and the second rating score based on uploaded financial statements uploaded by at least one of the seller and the payer, respectively.

16. The apparatus according to claim 11, the processor further to calculate at least one of the first rating score and the second rating score based the Altman Z-score calculation formula.

17. The apparatus according to claim 11, the processor further to calculate a combined rating score based the first rating score and the second rating score, wherein the first and second rating scores of the offer include the combined rating score.

18. The apparatus according to claim 17, the processor further to weight the combined score towards one of the seller and the payer.

19. The apparatus according to claim 11, the processor further to calculate the discounted price based on linear regression, with a maximum discount applied to the discounted price at a beginning of a specified time and a minimum discount applied to the discounted price at an end of the specified time.

20. The apparatus according to claim 11, the processor further to calculate the first rating score based on at least one seller criteria include assets, current liabilities, working capital, retained earnings, earnings before interest and taxes, total liabilities, total assets, gross sales, social media rating, liquidity, payment discipline, corporate intelligence information, and court proceedings.
